(19) United States
(12) Patent Application Publication
(10) Pub. No.: US 2006/0266380 A1
(43) Pub. Date: Nov. 30, 2006

(54) Cleaning sheet and cleaning method using same

(76) Inventors: Eiji Yamanaka, Osaka (JP); Masanobu Yoneda, Osaka (JP); Takahiro Yatagai, Osaka (JP); Osamu Degawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/439,252

(22) Filed: May 24, 2006

(30) Foreign Application Priority Data
May 26, 2005 (JP) 154154/2005
Apr. 17, 2006 (JP) 113355/2006

(51) Int. Cl. B08B 7/00; B32B 3/00

(52) U.S. Cl. 134/6; 428/156

(57) ABSTRACT

According to the present invention, of the both surfaces of a cleaning sheet, a contact face to be rubbed against a cleaning object is a concave convex plane containing a convex part 1 and a concave part 2. By rubbing this concave convex plane against a cleaning object, a removal target (e.g., paste accumulated on the back of screen printing plate) attached to a cleaning object can be effectively removed.

### FIELD OF THE INVENTION

The present invention relates to a sheet for cleaning an object to be cleaned (hereinafter a cleaning object) by removing an object to be removed (hereinafter a removal target) attached thereto, such as paste, ink and the like. More particularly, the present invention relates to a cleaning sheet for wiping off a fluorescent material paste spread on the back of the mating face of a screen printing plate, during production and the like of a fluorescent material layer incorporated in a plasma display panel (PDP), and a cleaning method using the sheet.

### BACKGROUND OF THE INVENTION

In recent years, PDP (particularly, color PDP) is becoming bigger and more highly defined, and the arrangement pattern of an RGB fluorescent material in its fluorescent material layer is becoming ultrafine and highly dense.

In a step for forming a fluorescent material layer, as shown in FIG. 14(a) with a schematic sectional view, each fluorescent material for the three primary colors of RGB is disposed on a substrate 100 to draw high definition stripes. The arrangement pattern comprises repeats of a unit consisting of three rows of (R, G, B). The fluorescent material zones have a division wall 110 in between. As a result, the fluorescent materials are each disposed in grooves formed in stripes on the plate face of a substrate 100.

To dispose each fluorescent material on a substrate in the above-mentioned high definition pattern, screen printing is used as shown in FIG. 14(b).

FIG. 14(b) shows one enlarged groove of a fluorescent material layer shown in FIG. 14(a), wherein a screen printing plate S is superimposed on a substrate 100, and a fluorescent material paste 200 is fed into the groove from an opening (through hole) S20.

The thick wavy line drawn inside the screen printing. plate suggests what is called a “screen” woven with a wire made of a polymer material or a metal material. As shown in FIG. 15, a screen S10 is exposed in the opening of a plate face of a screen printing plate and a fluorescent material paste is printed on the surface of an object through a mesh thereof.

For printing a fluorescent material in a stripe, it is ideal to prevent an invasion of the adjacent fluorescent material paste, and to set a fluorescent material paste of each color in a pure state in the groove. When adjacent fluorescent materials are mixed even topically, the mixed part alone cannot provide an accurate display. Therefore, a high quality product is particularly required to show an extremely accurate arrangement of fluorescent materials.

By screen printing, however, a fluorescent material paste 201 comes to remain and be deposited on a face S1 at the contact side of a screen printing plate S (particularly around an opening S20) after a certain number of printing performances, as shown in FIG. 14(b). Such remainder and deposit of the fluorescent material paste that ran out of the opening and accumulated on the back surface of the printing plate is referred to as a “back paste” in this specification. The residue (back paste) that attached to the top of division walls prevents accurate and beautiful arrangement of the fluorescent materials.

Conventionally, to prevent problems in the quality due to the above-mentioned back paste during the screen printing for the production of PDP, a method of removing the back fluorescent material paste with an adhesive sheet is known (e.g., JP-A-2000-177110, JP-A-2001-348541).

The adhesive sheets described in these publications all intend to remove the fluorescent material paste while suitably absorbing the solvent in the paste.

However, the composition of the adhesive of adhesive sheets needs to be designed for each paste according to the SP value of a solvent in a paste (e.g., JP-A-2001-347240 (JP-B-3280367)). In addition, an adhesive of a cleaning sheet for a screen printing plate should be designed to balance an absorption amount of a solvent and an adhesive force. When these adhesive sheets are used, since they are adhered to and peeled off from a cleaning object, at least the same area of an adhesive sheet as the area to be cleaned needs to be consumed.

An object of the present invention is to provide a cleaning sheet capable of effectively removing a removal object such as a paste remaining or deposited, for example, on the back of a screen plate during screen printing and the like, irrespective of the kind of the solvent contained therein.

### SUMMARY OF THE INVENTION

The present inventors have conducted intensive studies in an attempt to achieve the above-mentioned object, and found that the back paste alone can be scraped off by processing the contact face of a sheet into a concave convex shape and rubbing the convex face against a cleaning object like a wiper, by which the back paste thus scraped off remains in the concave part. Thus, they have found that such a simple structure enables preferable cleaning, which resulted in the completion of the present invention.

Accordingly, the present invention has the following characteristics.
(1) a cleaning sheet for removing a removal target by rubbing the sheet against a cleaning object, wherein

at least one of the both surfaces of the sheet is a contact face to be rubbed against the cleaning object and the contact face has a concave convex plane.
(2) The cleaning sheet of the above-mentioned (1), wherein the concave convex pattern is a stripe pattern comprising ridge line-like convex parts disposed at intervals on a sheet face.
(3) The cleaning sheet of the above-mentioned (2), wherein the sheet has a form of a band tape, and the ridge line-like convex part extends in a direction forming a right angle or a non-right angle with the longitudinal direction of the tape.
(4) The cleaning sheet of the above-mentioned (2), wherein the ridge line-like convex part has a cross sectional shape when cut perpendicularly to the longitudinal direction of the ridge line of any of a rectangular wave, a triangular wave, a saw tooth wave, a semicircle and a semi-ellipse.
(5) The cleaning sheet of the above-mentioned (2), wherein the ridge line-like convex part has a full width of 10 μm-2000 μm and a height of 10 μm-1000 μm.
(6) The cleaning sheet of the above-mentioned (1), wherein the concave convex pattern forms a net shape comprised of ridge line-like convex parts on a sheet face, and the net comprises meshes of relative concaves.
(7) The cleaning sheet of the above-mentioned (6), wherein the ridge line-like convex part has a cross sectional shape when cut perpendicularly to the longitudinal direction of the ridge line of any of a rectangular wave, a triangular wave, a saw tooth wave, a semicircle and a semi-ellipse.
(8) The cleaning sheet of the above-mentioned (6), wherein the ridge line-like convex part has a full width of 10 μm-2000 μm and a height of 10 μm-1000 μm.
(9) The cleaning sheet of the above-mentioned (1), wherein the concave convex pattern is formed by disposing separately occurring concave parts at random or regularly on a sheet face.
(10) The cleaning sheet of the above-mentioned (1) used for cleaning a screen printing plate.
(11) The cleaning sheet of the above-mentioned (1), wherein the cleaning object is a screen printing plate to form a fluorescent material layer of a flat panel display, and the removal target is a fluorescent material paste.
(12) A cleaning method using the cleaning sheet of the above-mentioned (1), which comprises rubbing a contact face of the cleaning sheet against a cleaning object to remove a removal target thereon.
(13) The cleaning method of the above-mentioned (12), wherein the cleaning sheet comprises a concave convex pattern which is a stripe pattern comprising ridge line-like convex parts disposed at intervals on a sheet face.
(14) The cleaning method of the above-mentioned (13), wherein the ridge line-like convex part has a cross sectional shape when cut perpendicularly to the longitudinal direction of the ridge line of any of a rectangular wave, a triangular wave, a saw tooth wave, a semicircle and a semi-ellipse.
(15) The cleaning method of the above-mentioned (13), wherein the ridge line-like convex part has a full width of 10 μm-2000 μm and a height of 10 μm-1000 μm.
(16) The cleaning method of the above-mentioned (12), which is used for cleaning a screen printing plate.
(17) The cleaning method of the above-mentioned (12), wherein the cleaning object is a screen printing plate to form a fluorescent material layer of a flat panel display and the removal target is a fluorescent material paste.

### BRIEF DESCRIPTION OF THE DRAWINGS

FIG. 1 schematically shows a sectional structure of the cleaning sheet of the present invention. In the Figure, each symbol shows the following.
1; convex part, 2; concave part, wl; width of convex part, w2; width of concave part, h2; height of convex part, B; base sheet, h1; thickness of base sheet

FIG. 2 schematically shows a sectional view of the cleaning sheet of the present invention during use.

FIG. 3 shows an example of a concave convex pattern when the cleaning sheet of the present invention is a tape band.

FIG. 4 shows an example of a concave convex pattern when the cleaning sheet of the present invention is a tape band.

FIG. 5 shows an example of a concave convex pattern when the cleaning sheet of the present invention is a tape band.

FIG. 6 shows an example of a cross sectional shape of concaves and convexes of the cleaning sheet of the present invention.

FIG. 7 shows an example of a cross sectional shape of concaves and convexes of the cleaning sheet of the present invention.

FIG. 8 shows an example of a cross sectional shape of concaves and convexes of the cleaning sheet of the present invention.

FIG. 9 shows an example of a cross sectional shape of concaves and convexes of the cleaning sheet of the present invention.

FIG. 10 is a perspective view showing an example of a concave convex pattern of the cleaning sheet of the present invention.

FIG. 11 explains the procedures for evaluating the cleaning sheets of Examples and Comparative Example.

FIG. 12 explains the procedures of Example 1 for evaluating the cleaning sheets of Examples 1-4 and Comparative Example.

FIG. 13 explains the procedures of Example 2 for evaluating the cleaning sheets of Examples 5-12 and Comparative Example.

FIG. 13(a) shows a plate surface of a screen printing plate used as a cleaning object in the Examples and FIG. 13(b) shows constitution of the main part of the cleaning tester used for the evaluation.

FIG. 14 schematically shows a sectional view of arrangement of a fluorescent material in the production process of a fluorescent material layer of PDP and a production method thereof. The respective fluorescent materials R, G, B are disposed in a groove extending in a perpendicular direction to the sheet.

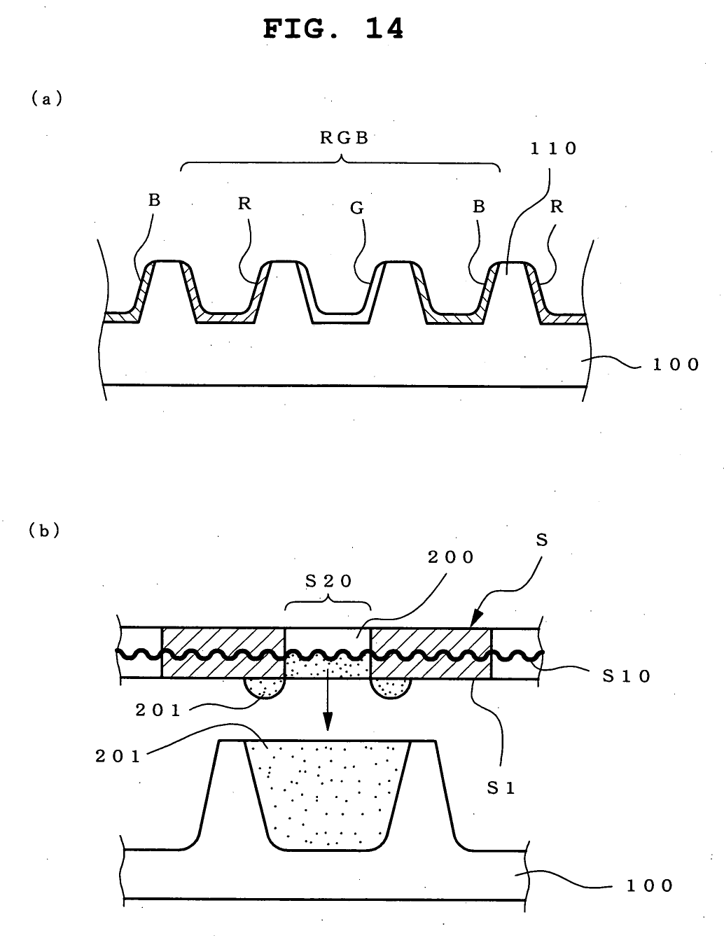

FIG. 15 is a partial schematic diagram of a plate surface of a screen printing plate used for the production of a fluorescent material layer of PDP.

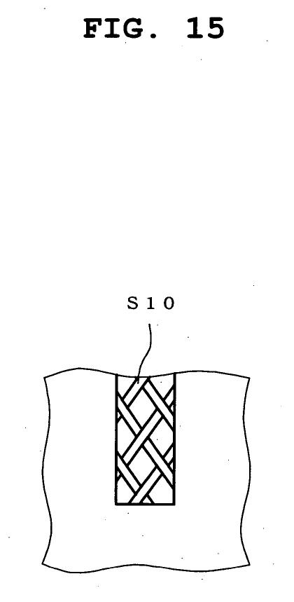

### DETAILED DESCRIPTION OF THE INVENTION

In the following explanation of the concave convex structure of the cleaning sheet of the present invention (the sheet), the sheet is sometimes explained as consisting of a sheet to be the base (hereafter to be referred to as a “base sheets”) and a convex part formed thereon. However, these are references to simply explain shapes and sizes of respective parts around the convex part, which doe not limit the forming process thereof. The shape of the sheet can be interpreted to comprise concave parts in the original thick sheet surface, and the residual part is a relatively convex part. In the present invention, the term “sheet” is a concept including a “film”.

FIG. 1 schematically shows a sectional structure of the sheet. The material constituting the sheet and the like are not particularly limited as long as the contact face to be rubbed against a cleaning object can be processed to have a concave convex plane, and appropriately selected for use from organic materials and inorganic materials according to the kind of the cleaning object.

The sheet has a contact face (upper surface of sheet in the embodiments shown in the Figure), which is at least one of the both surfaces, to be rubbed against a cleaning object, and the contact face is a concave convex plane comprising a convex part 1 and a concave part 2.

While an embodiment having only one surface of the sheet as a contact face is conventional, the both surfaces may be contact faces depending on the use.

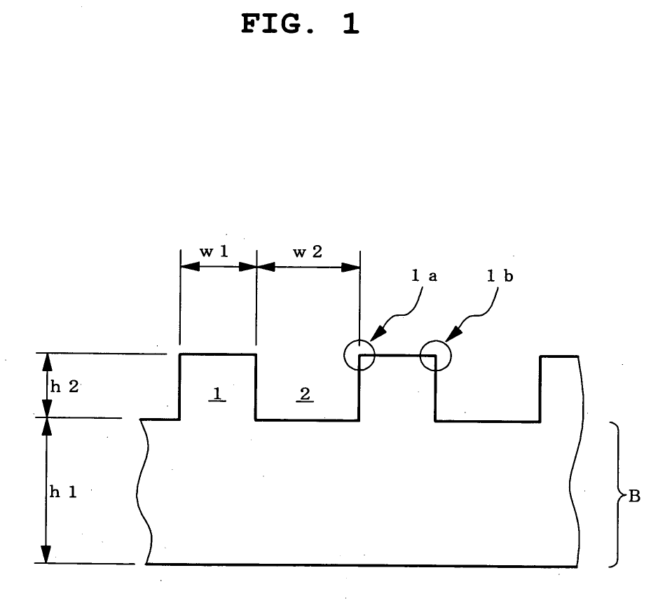

In a preferable use of the sheet, a peak part is rubbed against the surface of a cleaning object (e.g., screen printing plate and the like) while largely curving the sheet using a roller R, as shown in FIG. 2. Thus, the materials constituting the sheet preferably confer suitable flexibility and mechanical strength to the sheet. From this aspect, the materials constituting the sheet are preferably polymer materials. In addition, the aforementioned polymer materials preferably confer appropriate stiffness that do not damage a cleaning object such as a screen printing plate and the like, and appropriate elasticity that affords gap-free adhesion of a convex part to the plate surface upon deformation of the sheet during the contact, to the sheet.

Besides the above-mentioned adhesive sheets of JP-A-2000-177110 and JP-A-2001-348541, a composite where a porous layer such as a net and the like is laminated on an adhesive layer (JP-A-11-224414 and the like) is known as a sheet for cleaning the stain of the surface of an article.

On the other hand, the present invention adopts an embodiment of a simple concave convex substrate where a convex part is integrally formed on a base sheet. When a cleaning object is a screen printing plate, a printing paste that is accumulated on the back of the screen printing plate is the removal target.

When a sheet having such a constitution is rubbed against a plate surface S1 of a screen printing plate S, as shown in FIG. 2, a back paste 201 alone can be scraped and removed with a convex part 1. A paste taken by the convex part 1 is collected in a concave part 2 (e.g., 202).

In other words, since the cleaning sheet physically scrapes the back side of the screen plate, cleaning is done irrespective of the kind of the solvent in the paste.

The polymer materials are not particularly limited as long as they are various kinds of plastic and, for example, polyethylene, polypropylene, polyvinyl chloride, polyamide, polyurethane, cellophane and the like can be mentioned, which are used alone or in a mixture of two or more kinds thereof. Of these, various polyolefin resins such as polyethylene are particularly preferable materials in consideration of the producibility, cost, processability of concave convex plane and the like. As the polyolefin resins, polyethylene resins (e.g., high density polyethylene, medium density polyethylene, low density polyethylene, linear low density polyethylene, ultra-low density polyethylene, ethylene-vinyl acetate copolymer, ethylene-ethyl acrylate copolymer, ethylene-propylene copolymer and the like), polypropylene resins (e.g., polypropylene and the like), thermoplastic elastomers and the like can be mentioned. These resins may contain known additives such as pigment, filler, antioxidant, lubricant and the like.

The constitution of the sheet may be any of a single layer structure made of a single material in the entirety and a multi-layer (laminate) structure made of different material layers.

The removal target by the sheet is not particularly limited, and a wet semi-solid containing a solvent, such as various pastes, ink, glue, adhesive, paint and the like can be mentioned. The removal target does not necessarily contain a solvent and includes a wet semi-solid materials free of a solvent. As discussed in the Background Art, the screen printing for forming a fluorescent material layer of PDP is associated with problems due to the high definition. Thus, when the removal target is a fluorescent material paste for forming a fluorescence layer of PDP, the usefulness of the sheet becomes particularly remarkable.

When the removal target contains a solvent, the solvent may be, for example, aliphatic hydrocarbons such as hexane, heptane, mineral spirit and the like; alicyclic hydrocarbons such as cyclohexane and the like; aromatic hydrocarbons such as toluene, xylene, solvent naphtha, tetralin, dipentene and the like; alcohols such as methyl alcohol, ethyl alcohol, isopropyl alcohol, butyl alcohol, isobutyl alcohol, s-butyl alcohol, cyclohexyl alcohol, 2-methylcyclohexyl alcohol, tridecyl alcohol and the like; esters such as methyl acetate, ethyl acetate, isopropyl acetate, butyl acetate and the like; ketones such as acetone, methyl ethyl ketone, methyl isobutyl ketone, cyclohexanone, methylcyclohexanone, diacetone alcohol, isophorone and the like; glycols such as ethylene glycol, propylene glycol, diethylene glycol, triethylene glycol, dipropylene glycol and the like; glycol ethers such as butyl cellosolve, propylene glycol monomethyl ether, propylene glycol monoethyl ether, propylene glycol monobutyl ether, diethylene glycol monobutyl ether and the like; glycol ether esters such as butyl cellosolve acetate, propylene glycol monomethyl ether acetate, propylene glycol monoethyl ether acetate, diethylene glycol monobutyl ether acetate and the like; water and the like.

When the removal target is a screen printing ink, solvents having a medium boiling point (boiling point: about 120-230° C.) and solvents having a high boiling point (boiling point: about 230-320° C.) are mostly used.

Furthermore, as a solvent contained in a fluorescent material paste of PDP, for example, solvents having a high boiling point (boiling point: about 230-320° C.) such as diethylene glycol monobutyl ether acetate, diethylene glycol monobutyl ether, diethylene glycol monobutyl ether acetate/diethylene glycol monobutyl ether [9/1 (weight ratio)] and the like, and the like can be mentioned.

The concave convex pattern of a concave convex plane is not particularly limited and, for example, a concave convex pattern in which separately occurring, ridge-line like convex parts are disposed randomly or regularly on a flat base sheet, a concave convex pattern in which separately occurring, ridge-line like non-penetrated convex parts are disposed randomly or regularly on the main plane of a flat sheet with the entire thickness of the sheet and the like can be mentioned.

They are variations of concave convex patterns, and a concave convex pattern looking like separately occurring concave parts may be interpreted to be a pattern wherein ridge line-like convex parts intersect in a net shape. Conversely, a concave convex pattern looking like separately occurring convex parts may be interpreted to be a pattern wherein groove-like concave parts intersect in a net shape. Whichever the concave convex pattern may be, for convenience of explanation, the shape and size of each part is explained with a convex part expressed as being formed on the upper surface of a base sheet.

The embodiment of the convex part is preferably a long string of ridge line-like (mountain range) protrusions having a constant height rather than a dot-like separately occurring protrusion, whereby the ridge line-like convex part can act as a wiper blade and scrape the removal target without a trace.

Therefore, when the convex part is like a ridge line, the direction of the sheet advancing while rubbing itself against the surface of a cleaning object should form an angle with the longitudinal direction of the ridge line of the convex part.

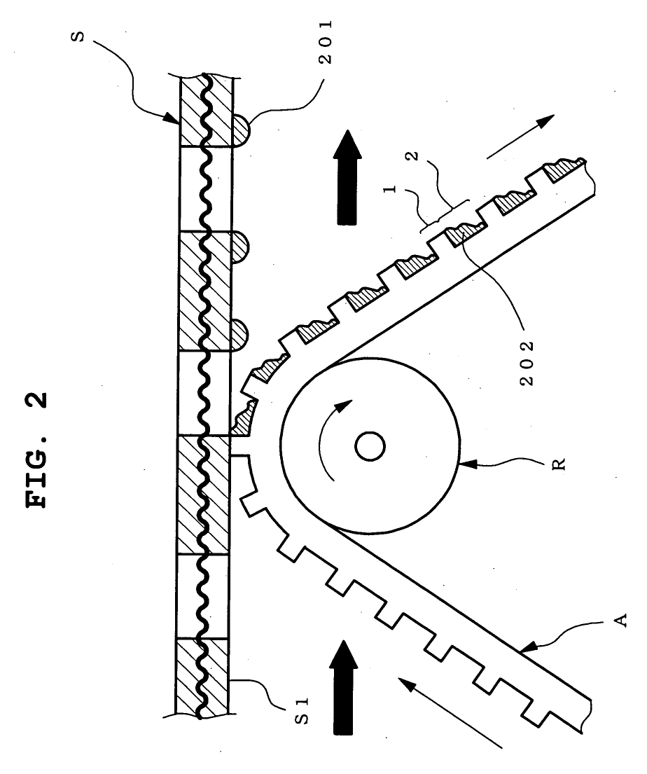

Conversely, when the sheet has a form of a tape band, as shown in FIG. 3, and the direction in use has been determined in relation to the outer shape of the sheet, the longitudinal direction of the ridge line-like convex part is a direction forming a right angle with the direction in use of the sheet (longitudinal direction of the tape in FIG. 3), as shown in FIG. 3(a), or a direction forming an angle θ1 other than the right angle (0°<θ1<180°), as shown in FIG. 3 (b).

An embodiment where an angle θ1 other than the right angle is formed is preferable, because the bottom of the concave part does not easily touch a cleaning object during cleaning even when a concave part has a greater width, thus reducing a decrease in the removability due to the contact with the bottom of the concave part.

In this case, the angle θ1 defined at the acute angle side is desirably 30°<θ1<90°, particularly 45°<θ1<90°.

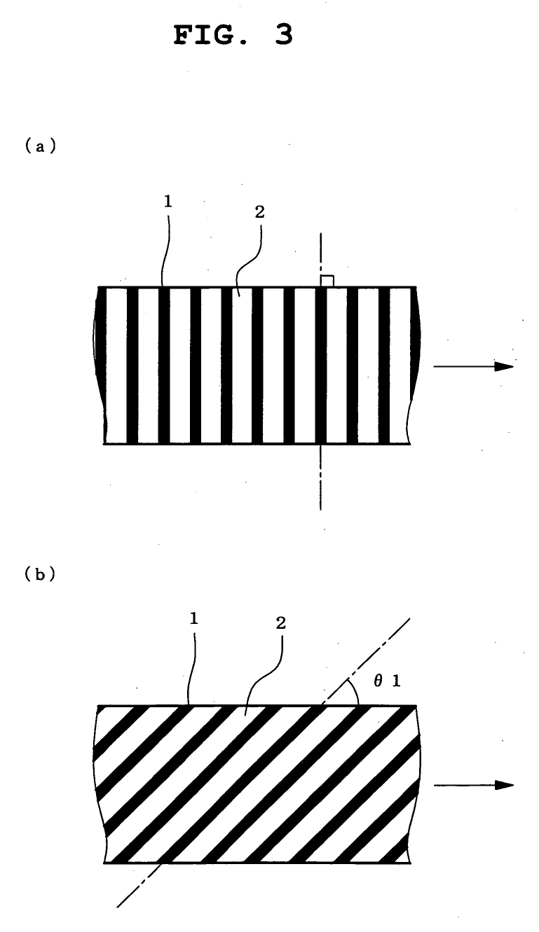

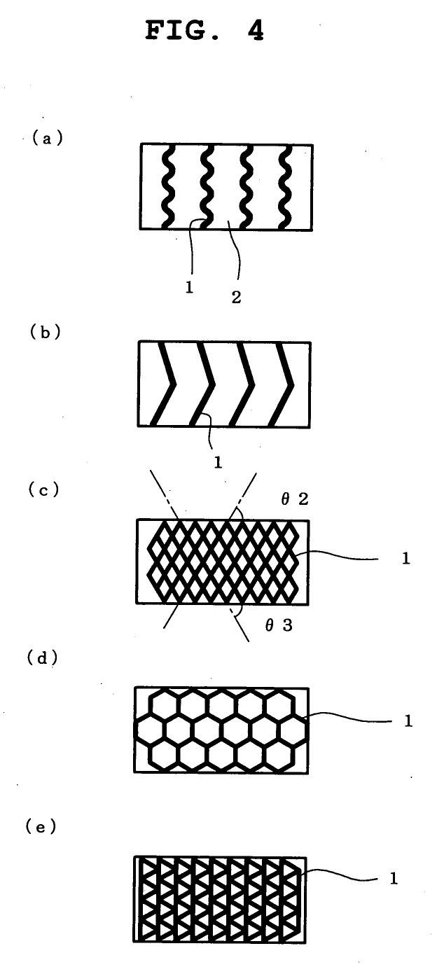

When the convex part is like a ridge line, a pattern depicted by the concaves and convexes on a concave convex plane is, for example, a stripe-like concave convex pattern wherein ridge line-like convex parts 1 are disposed at intervals on the main surface of a base sheet, as shown in FIGS. 3(a), 3(b), FIGS. 4(a), 4(b), a net-shape concave convex pattern wherein ridge line-like convex parts are disposed in a net shape on the ain surface of a base sheet, as shown in FIGS. 4(c)-(e), a concave convex pattern wherein broken lines matching an opening of a cleaning object, any curves and polygonal lines are regularly or irregularly dispersed or disposed on the main surface of a base sheet, as shown in FIGS. 5(a)-(f) and the like can be mentioned. The thick lines in these Figures merely show patterns drawn by the apexes of the convex parts, and the width of the thick lines does not correspond to a width wl of the rectangular wave-like convex part as shown in FIG. 1.

In the stripe pattern of FIG. 4(a), while the ridge line of the convex part 1 is wavy, it may be any curve. In the stripe pattern of FIG. 4(b), the linear ridge line of the convex part 1 is a polygonal line. In this case, the advancing direction of the sheet (right or left direction of the Figure) can be appropriately determined according to the accumulation of the removal target and the like.

In the net-shape pattern of FIG. 4(c), the ridge line of the convex part forms a lattice mesh. The angles θ2, θ3 of the inclination of two intersecting ridge lines may be the same or different. FIGS. 4(d), (e) show examples of other net-shape pattern, wherein FIG. 4(d) is a hexagonal pattern and FIG. 4(e) is a mesh pattern with a triangle as the minimum constitution unit.

In the embodiments of FIGS. 5(a), (d), a ridge line-like convex part 1 depicts a separately occurring ring, in the embodiments of FIGS. 5(b), (e), a ridge line-like convex part 1 depicts a separately occurring short polygonal line, and in the embodiments of FIGS. 5(c), (f), a ridge line-like convex part 1 depicts a separately occurring short straight line. In all these embodiments, the separately occurring convex parts are disposed on the main surfaces of the base sheets regularly (FIGS. 5(a)-(c)) or randomly (FIGS. 5(d)-(f)). In all these embodiments, the separately occurring shapes that the ridge line-like convex parts 1 draw may be the same or different in size, and a large one and a small one may be regularly disposed or completely irregularly dispersed in a mixture.

In all of the above-mentioned patterns, the parts other than the convex part 1 are relative concave parts 2. The pattern shown as the ridge line of the convex parts may be a pattern of the grooves of the concave parts.

In every pattern, the direction in use of the sheet and that of the ridge line of the convex part are appropriately determined to form an angle. In addition, the exemplified patterns are mere examples of the concave convex patterns, and any concave convex pattern may be formed according to the condition of the surface of the cleaning object, a removal target and the like.

When the convex part is like a ridge line, the shape of the convex part, particularly, the cross sectional shape of the convex part cut perpendicularly to the longitudinal direction of the ridge line (hereinafter to be simply referred to as a “cross sectional shape”) affects the effect of the edge and manner of cramping upon contact of the convex part with a cleaning object, and the like, which in turn greatly influences the removability of the removal target.

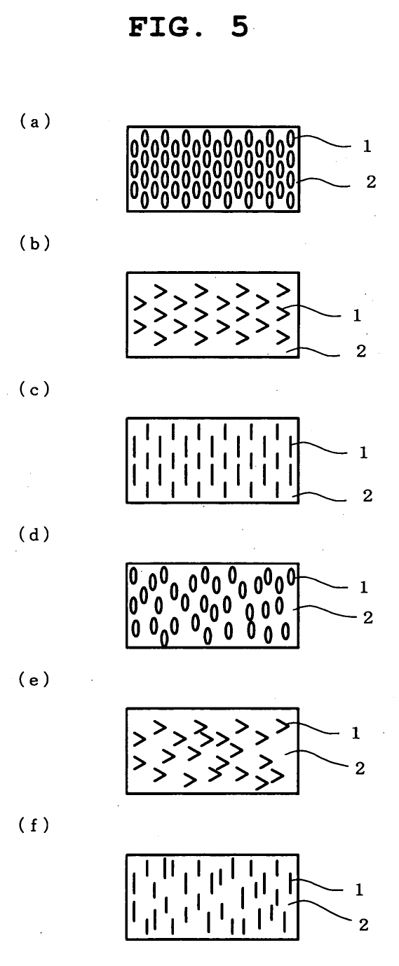

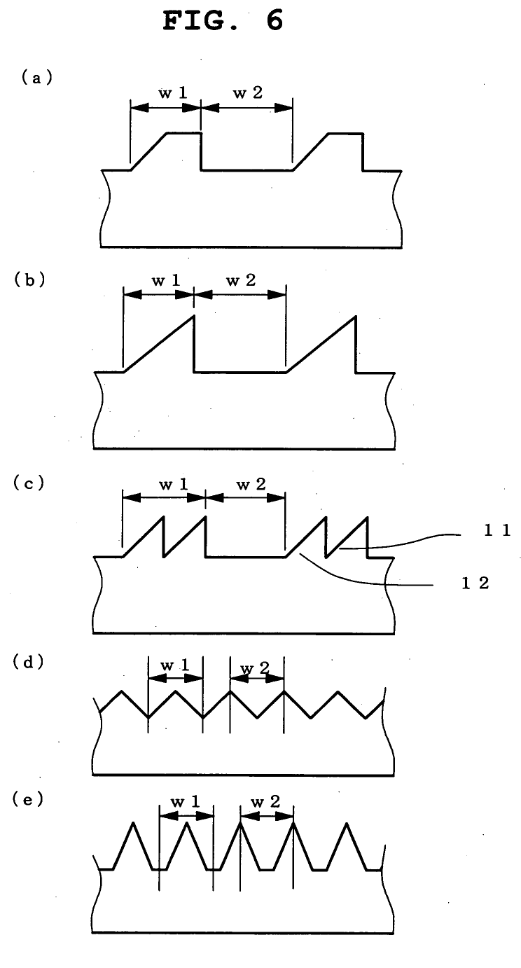

The cross sectional shape of the convex part can be appropriately determined according to the viscosity of the removal target and the mechanical properties of the material constituting the sheet. For example, the rectangular wave (including trapezoid of FIG. 6(a)) shown in FIG. 1, various saw tooth waves shown in FIGS. 6(b)-(e), triangular wave, semi-circle shown in FIG. 7(a), semi-ellipse shown in FIG. 7(b) and the like are preferable cross sectional shapes.

The sheet having the rectangular waves shown in FIG. 1 may advance in the direction of either side because edges 1a, 1b of the shoulder of the convex part are the same. Since the width w1 of the convex part is almost the same as the distance from the apex to the base part, the convex part has relatively high rigidity, and provides a strong blade with less flexure.

In contrast, the triangular wave shown in FIG. 6(b) has directionality for use, and the sheet can act more effectively with the edge of the apex of the convex part on the removal target when it advances in the right direction in the Figure. Moreover, the tip of the convex part easily bends as compared to the rectangular wave, which facilitates following the concaves and convexes on the plate surface. Furthermore, a convex part like a triangular wave is beneficial in that the volume of the concave part increases for the inclined plane.

The cross sectional shape of FIG. 6(a) is a kind of a rectangular wave, which has the characteristics of a rectangular wave of FIG. 1 and those of a triangular wave of FIG. 6(b) in combination.

The arrangement of the convex parts is not necessarily at even intervals and, for example, the intervals may be dense or sparse as shown in FIG. 6(c).

When the convex part forms an angle rather than the right angle with the advance direction as shown in FIG. 3(b), explanation may be easy when the cross sectional shape of the convex part is parallel to the advance direction of the ridge line rather than perpendicularly to the longitudinal direction.

The ridge line-like convex part having a rectangular wave section as shown in FIG. 1 preferably has a width w1 of about 10 μm-2000 μm. Depending on the height h2 of the convex part, a smaller width w1 than this range makes the deformation such as flexure and the like grows, and its function as a blade becomes difficult. On the other hand, a width of the convex part which is wider than the aforementioned range is useless because the upper surface of the rectangular wave convex part does not contribute to the removal or maintenance of the removal target.

When evaluated based on the below-mentioned method of Example 1, more preferable range of width w1 of the convex part is 50 μm-2000 μm, and 100 μm-1000 μm is particularly effective for the removal of the fluorescent material paste of PDP.

On the other hand, according to the evaluation method of the below-mentioned Example 2, wherein a screen printing plate was used as a cleaning object and the manner of use of the sheet was reproduced in detail, more preferable range of the width w1 of the convex part is 15 μm-1000 μm, 20 μm-500 μm is particularly effective for the removal of the fluorescent material paste of PDP particularly, and 25 μm-50 μm was evaluated to be particularly fine in the evaluation test.

While the more preferable range of the width w1 of the convex part in Example 1 and that of the newly added Example 2 are somewhat different, it is caused by the different objects to be cleaned and different evaluation methods. While the overall range of 10 μm-2000 μm held to be preferable in the present invention includes several preferable ranges obtained by multiple kinds of evaluations, there is no problem caused thereby. The same applies to the height of the convex part, the ratio of the height of the convex part to the whole thickness of the sheet and the width of the concave part to be mentioned below. These ranges are all preferable embodiments of the present invention. However, since the below-mentioned Example 2 reproduces conditions similar to those of an actual particular use, the reliability of the evaluation itself is high.

Since the height of the convex part (h2 of FIG. 1) influences not only the extent of deformation of the convex part, but also the volume of the removal target as the depth of the concave part, it is preferably decided in consideration of the delivery amount of the sheet when in use.

While the preferable height of the convex part varies depending on the convex part of the cross sectional shape, when the cross sectional shape is a rectangular wave, it is preferably about 10 μm-1000 μm. From the aforementioned range, when evaluated according to the evaluation method of the below-mentioned Example 1, the height of the convex part is more preferably 20 μm-800 μm and 30 μm-500 μm is particularly effective and free of waste for removing a fluorescent material paste of PDP. When evaluated according to the evaluation method of the below-mentioned Example 2, the height of the convex part is more preferably 10 μm-800 μm, and 13 μm-500 μm is particularly effective and free of waste for removing a fluorescent material paste of PDP. Particularly, 15 μm-30 μm was a fine evaluation by the test.

While the preferable ratio of the height of the convex part to the whole thickness of the sheet (thickness of base sheet+height of convex part) varies depending on the cross sectional shape of the convex part, by evaluation according to the evaluation method of the below-mentioned Example 1, it is 10-90%, preferably 20-85%, and 30-80% is particularly effective and free of waste for removing a fluorescent material paste of PDP. By evaluation according to the evaluation method of the below-mentioned Example 2, it is more preferably 10-85%, and 13-80% is particularly effective and free of waste for removing a fluorescent material paste of PDP. Particularly, 15%-30% was a fine evaluation by the test.

The width (w2 of FIG. 1) of the concave part influences, together with the aforementioned height of the convex part h2, the collection volume of a removal target.

A preferable width of the concave part varies depending on the cross sectional shape of the concave part. When the cross sectional shape of the concave convex is a rectangular wave, about 100 μm-3000 μm is a preferable range by the evaluation according to the evaluation method of the below-mentioned Example 1. By the evaluation according to the evaluation method of the below-mentioned Example 2, about 10 μm-3000 μm is a preferable range.

Though subject to change depending on the height of the convex part (depth of concave part), when the width of the concave part is smaller than the above range, the space for preserving the scraped removal target becomes smaller than the actual volume of the removal target and the object cannot be removed completely. On the other hand, when the width of the concave part is wider than the aforementioned range, the density of the convex part becomes too sparse and the removability of the removal target is degraded.

A more preferable range of the width w2 of the concave part by the evaluation according to the evaluation method of the below-mentioned Example 1 is 200 μm-3000 μm and 300 μm-2000 μm is particularly effective for removing a fluorescent material paste of PDP. By the evaluation according to the evaluation method of the below-mentioned Example 2, the width w2 of the concave part is more preferably 15 μm-3000 μm and 20 μm-2000 μm is particularly effective for removing a fluorescent material paste of PDP. Particularly, 50 μm-150 μm was a fine evaluation by the test.

When the cross sectional shape of the convex part is like a trapezoidal wave or a saw tooth wave as shown in FIGS. 6(a)-(c), or like a semicircle or a semi-ellipse as shown in FIGS. 7(a), (b), the full width w1 of the convex part is the width of the base part thereof. The width w2 of the concave part is the size of the rest.

When the distance between the positions of convex parts is not equal, the full width w1 of the convex part can be appropriately interpreted according to the intention of the design. For example, when sequential two convex parts 11, 12 are designed as a single convex part with a notched upper surface as shown in FIG. 6(c), the full width w1 of the convex part is a combination of two widths of the convex parts 11, 12.

When the cross sectional shape of the convex part is like a triangular wave free of a flat area at the bottom of the concave part as shown in FIG. 6(d), the full width w1 of the convex part is a width of the base part (i.e., width from the bottom of one valley to the bottom of the next valley), and the width w2 of the concave part is a width from the apex of one convex part to the apex of the next convex part, as shown in this Figure.

Provided that when the cross sectional shape of the convex part is like a triangular wave with a flat area at the bottom of the concave part as shown in FIG. 6(e), the full width w1 of the convex part is a width from the center of the bottom of one concave part to the center of the bottom of the next concave part, and the width w2 of the concave part is a width from the apex of one convex part to the apex of the next convex part, as shown in this Figure.

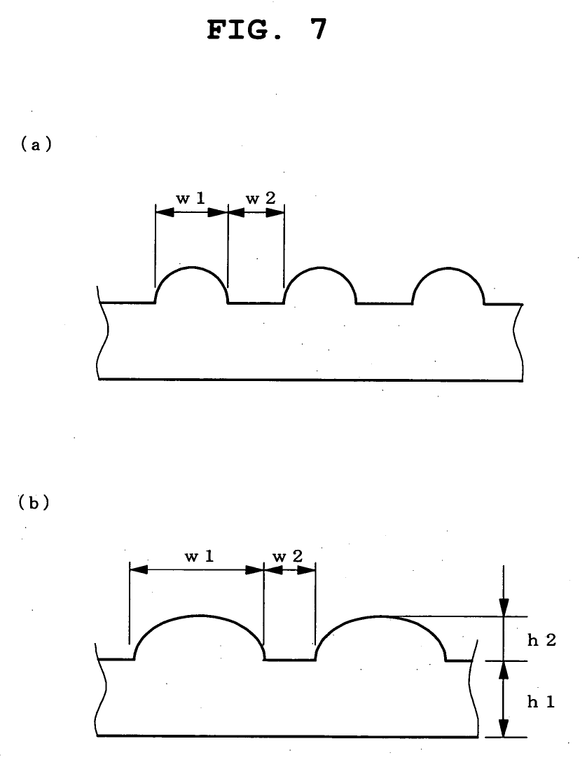

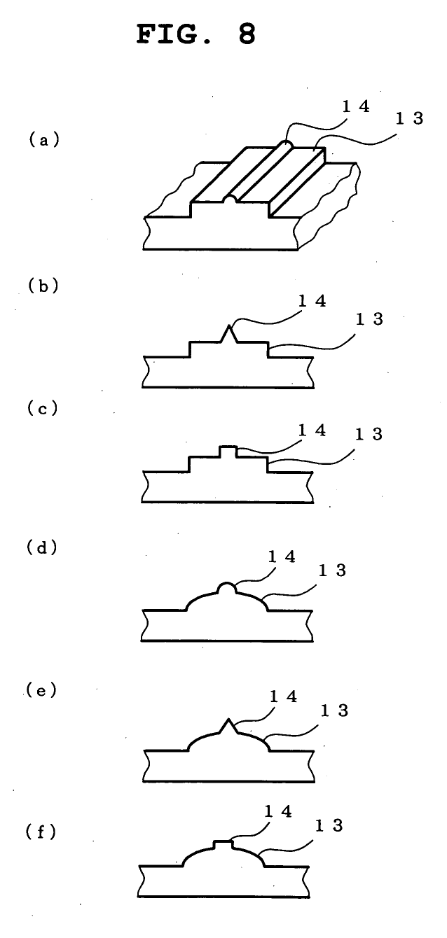

FIG. 8 and FIG. 9 show other embodiments of the cross sectional shape of the convex part.

In the embodiments of FIGS. 8(a)-(f), the cross sectional shape of the convex part have a multi-step shape, wherein a base part 13 of the convex part has a smaller ridge line-like protrusion 14 formed thereon. As the cross sectional shape of each part, a base part 13 of the convex part is like a rectangular wave in FIGS. 8(a)-(c), a base part 13 of the convex part is like a semi-ellipse in FIGS. 8(d)-(f), a ridge line-like protrusion 14 is like a semicircle in FIGS. 8(a), (d), a ridge line-like protrusion 14 is like a triangle in FIGS. 8(b), (e) and a ridge line-like protrusion 14 is like a quadrate in FIGS. 8(c), (d).

In the embodiment of FIG. 9, the cross sectional shape of the convex part is like a rectangular wave, wherein the height of each convex part (depth of concave part) is different from one another. The arrangement pattern of each different concave part may be periodical repeats of a particular kind, or randomly arranged concave parts having various depths. Furthermore, the width of the convex part and the width of the concave part may be uniform or non-uniform and can be appropriately designed so that the preferable removability can be exhibited according to the state of the face of the cleaning object, the removal target and the like.

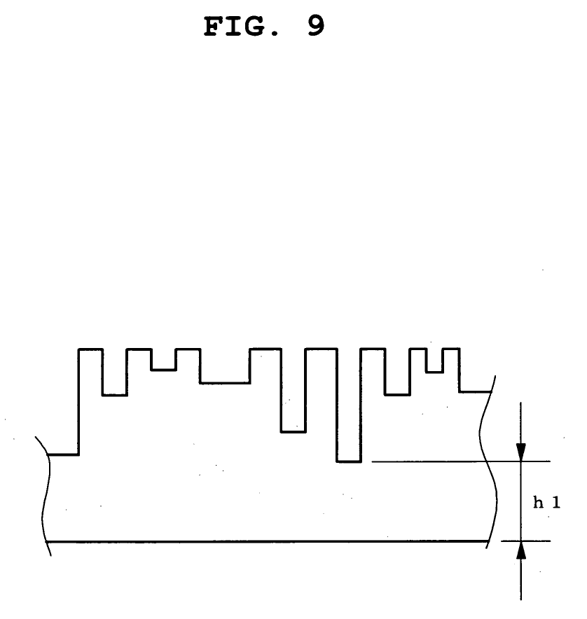

FIG. 10 is a perspective view showing other embodiments of the concave convex pattern. In the embodiments of this Figure, a lattice mesh pattern is produced by intersecting a ridge line-like convex part 15 forming an angle of 90°(can be other than 90°) with the advance direction of the sheet and a ridge line-like convex part 16 in the advance direction. In the embodiments of this Figure, moreover, a convex part 15 is a blade with which to scrape off a removal target and a convex part 16 is positioned lower than the convex part 15. As a result, the convex part 16 acts as a rib to improve the rigidity and mechanical strength of the sheet as a whole and simultaneously acts as a retaining division wall to prevent the removal target such as paste and the like thus caught from leaking from the side of the sheet.

In the above-mentioned various variations, the width of the convex part and the width of the concave part are generally the same for a rectangular wave. Since different cross sectional shapes have different volumes of the concave parts, numerical values can be appropriately amended according to the cross sectional shapes.

In the above, the preferable range of the width of the convex part and the preferable range of the width of the concave part are shown separately. To improve actual removal performance of the sheet, the ratio of the two in one pitch of a concave and a convex (or occupation rate of one of them), and the particular size combination of the width of the convex part and the width of the concave part are also important.

The ratio of the width of the convex part to the width of one pitch of the concave convex is about 2%-60%. When a fluorescent material paste of PDP is a removal object, 5%-40% is a more preferable range.

Specific examples of preferable combination of the width w1 of the convex part and the width of the concave part w2 when a fluorescent material paste of PDP is a removal object include (w1=100 μm, w2=400 μm) , (w1=200 μm, w2=800 μm), (w1=200 μm, w2=1800 μm ) and the like by the evaluation according to the evaluation method of the below-mentioned Example 1, and (w1=50 μm, w2=150 μm), (w1=50 μm, w2=100 μm), (w1=25 μm, w2=75 μm), (w1=25 μm, w2=50 μm) and the like by the evaluation according to the evaluation method of the below-mentioned Example 2.

These numerical values are preferable embodiments obtained by the evaluation method of each Example and do not limit the present invention.

While the thickness of the base sheet part of the sheet (hl of FIG. 1) varies depending on the strength of the polymer materials and the like, about 20 μm-1000 μm is a preferable range. As shown in FIG. 9, the thickness h1 of the base sheet b when the height of the convex part (=depth of concave part) is different is the thickness of the thinnest part (deepest concave part).

When the concave convex pattern is a concave convex pattern in which separately occurring, ridge-line like non-penetrated concave parts are disposed randomly or regularly on the main plane of a flat sheet with the entire thickness of the sheet, the concave convex pattern can be easily understood by an explanation focusing on the cross sectional shape of the concave part. Basically, however, the explanation is the same as that for the above-mentioned embodiments and concrete embodiments thereof are not particularly limited, wherein separately occurring or groove-like concave parts can be randomly or regularly disposed on the sheet surface. The groove-like concave part forms a pattern drawn by the above-mentioned ridge lines of the convex parts, such as a circular shape, straight line, polygonal line, wavy line and the like.

The depth and number of each concave part can be appropriately determined depending on the amount of the removal target.

While the production method of the sheet is not limited, for example, resin molding methods such as extrusion method, casting method and the like can be mentioned. More specifically, a method comprising pressing a molten-like resin against a forming roll with concave convex engravings and the like to transcribe the concave convex shapes, a method comprising pressing a roll having concave convex shapes and the like against a formed plastic film and the like can be exemplified, and an appropriate method can be selected depending on the shape of the object concave convex part.

The outline of one embodiment of the removal method using the sheet is explained by reference to FIG. 2.

A back paste 201 is already accumulated on a plate surface (surface in contact with a substrate for formation of a fluorescent material layer of PDP) S1 of a screen printing plate S. A contact face (concave convex plane) of a sheet A is pressed against the plate surface S1 from behind by a roller R. The sheet A is delivered from an unwinding apparatus (not shown) at the lower left side of the Figure following a thin arrow, passes the roller R and advances toward a reeling apparatus (not shown) at the lower right side. While the roller R preferably rotates synchronously with the feed so as to help delivery of the sheet, it may show an active rotation by a motive power, or a rotation as a pulley merely to follow the sheet. The roller R moves in parallel toward the right side of the Figure, while pressing the sheet A against the plate surface of the screen printing plate.

By this movement, the concave convex plane of the sheet A advances toward the right in contact with the plate surface S1 while scraping the back paste 201. At the same time, a new sheet is constantly supplied.

### EXAMPLES

### Example 1

In this Example, Example products having a concave convex pattern of a contact face with a cross sectional shape shown in FIG. 7(b), and having various values of width w1 of convex part, width w2 of concave part, thickness h1 of base sheet and height of the convex part h2 were produced, and the removal performance of the removal target and consumed amount of the sheet necessary for the removal of each product were evaluated.

As a Comparative Example product for comparison with the Example products, a conventional adhesive cleaning sheet (adhesive sheet) free of concave convex on a contact face was prepared, and the removal performance of the removal target, and the consumed amount of the sheet necessary for the removal were evaluated.

[Production of Example products]

A polyethylene resin having a density of 0.92 g/cm³, was extrusion molded from a T-type die at 190° C. to give a 150 μm-thick molten sheet, which was pressed with a concave convex squeezing roller and solidified by cooling to give a cleaning sheet of the present invention with a concave convex plane having a cross sectional shape as shown in FIG. 7(b).

Four kinds of Example products 1-4 were prepared by changing the width w1 of the convex part, width w2 of the concave part, thickness h1 of the base sheet and height h2 of the convex part. The size of each part of these Example products is as shown in the following Table 1.

[Production of Comparative Example product]

A mixture of an acrylic adhesive [butyl acrylate/acrylonitrile/acrylic acid (weight ratio:90/10/2) copolymer, 100 parts by weight] and an isocyanate crosslinking agent (15 parts by weight) was applied to one surface of a polyethylene film (substrate, thickness 0.10 mm) such that the thickness after drying became 13 μm, and dried to give an adhesive sheet as a Comparative Example product.

[Evaluation method]

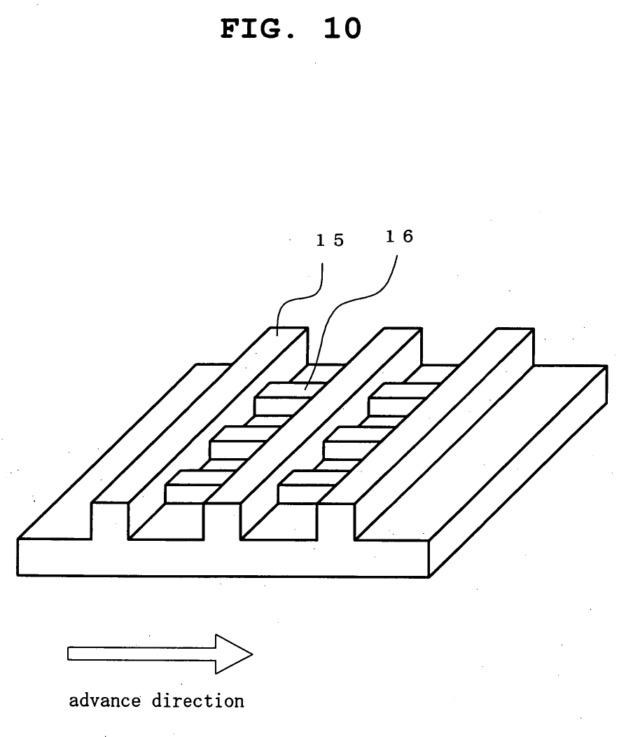

(i) A screen printing plate 30 is placed on a PET film 20 (thickness 75 μm) as shown in FIG. 11(a), a fluorescent material paste 31 as an ink is rubbed against the plate through a screen with a squeegee 32, as shown in FIG. 11(b), to form a quadrate print area having a width of not less than 40 mm and a length of 100 mm. The total amount of coating is about 25 g/m².

(ii) An Example product sheet A is adhered to the outer circumference of a roller core R (diameter 80 mm, width 40 mm, weight 1 kg) with the concave convex plane facing outward as shown in FIG. 11(d) to give a cleaning roller. The roller core is connected to the rotation shaft of a motor and the number of revolutions and rotational direction are controllable. As shown in FIG. 11(c), while moving the whole cleaning roller on the coated fluorescent material paste at 1 m/min, the roller is simultaneously rotated in a counter-clockwise direction for a length of 50 mm as shown in FIG. 11(d). As a result, the convex part moves in the advance direction while scraping the paste.

The sheet to be adhered to the roller core is processed into a width 40 mm, and the direction of the ridge line of the convex part is, as shown in FIG. 11(c), perpendicular to the advance direction of the roller R.

The removal performance of the adhesive sheet of the Comparative Example product was confirmed by a method comprising adhering an adhesive surface to a paste, and peeling off the adhesive sheet 1 sec later, without using a roller.

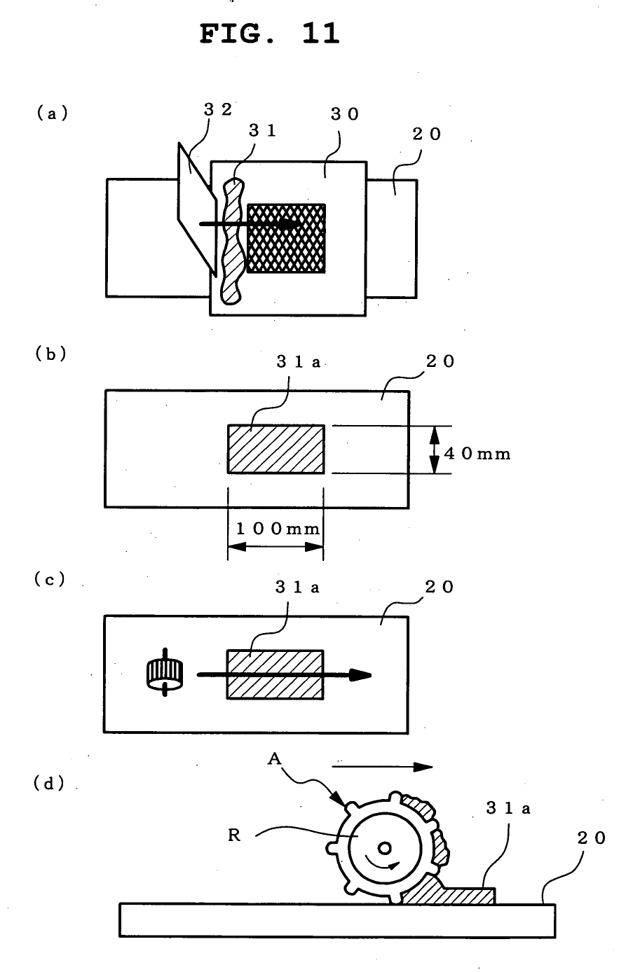

(iii) The remainder of the paste on the PET film is visually evaluated. As shown in FIG. 12(a), when the removal performance is good, no paste remains after passage of the cleaning roller. Conversely, as shown in FIG. 12(c), when the paste spills from the concave part, the paste remains after passage of the cleaning roller as shown in FIG. 12(b), because the paste cannot be removed completely from the middle of the passage. To avoid spill of the paste from the concave part, the roller may be rotated more often to feed new concaves and convexes for removal of the paste. However, it means increase in the sheet consumption.

The sheet amount to be used, paste removal performance, and overall evaluation of Example products 1-4 and Comparative Example product are respectively shown in the following Table 1. For paste removal performance and overall evaluation, “◯” means fine, “Δ” means not fine and “x” means poor.

TABLE 1

| | | | | | | paste | |
|---|---|---|---|---|---|---|---|
| | | | | | amount of | removal | overall |
| | w1 | w2 | h1 | h2 | sheet | perfor- | evalua- |
| | [μm] | [μm] | [μm] | [μm] | used [mm] | mance | tion |
| Example | 400 | 1600 | 90 | 60 | 50 | ◯ | ◯ |
| product 1 | | | | | | | |
| Example | 200 | 800 | 90 | 60 | 50 | ◯ | ◯ |
| product 2 | | | | | | | |
| Example | 100 | 400 | 100 | 50 | 50 | ◯ | ◯ |
| product 3 | | | | | | | |
| Example | 200 | 1800 | 90 | 60 | 50 | ◯ | ◯ |
| product 4 | | | | | | | |

| | | | | |
|---|---|---|---|---|
| Comparative | adhesive sheet | 100 | ◯ | Δ |
| Example | | | | |
| product 1 | | | | |

As is clear from the above-mentioned Table, Example products 1-4 and Comparative Example product were fine in paste removal performance. However, while the sheet amount used of the Example products 1-4 was 50 mm, the Comparative Example product required the same length of the sheet as the paste coat area to be removed since the product was of an adhesive type. Thus, the Comparative Example product was uneconomical as compared to the Example products, which resulted in the overall evaluation of not fine.

According to the present invention, the paste that is accumulated on the plate surface of the screen printing plate could be removed effectively with a small amount of the sheet to be used.

### Example 2

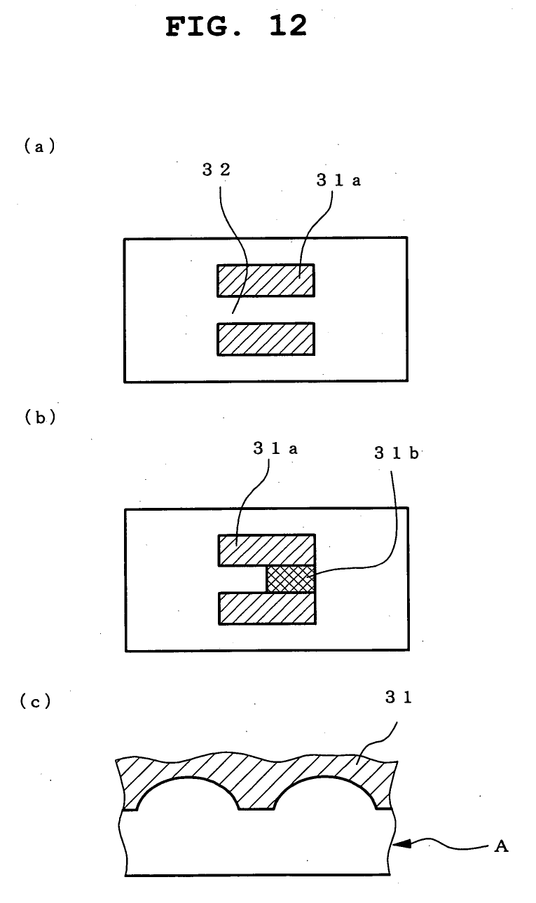

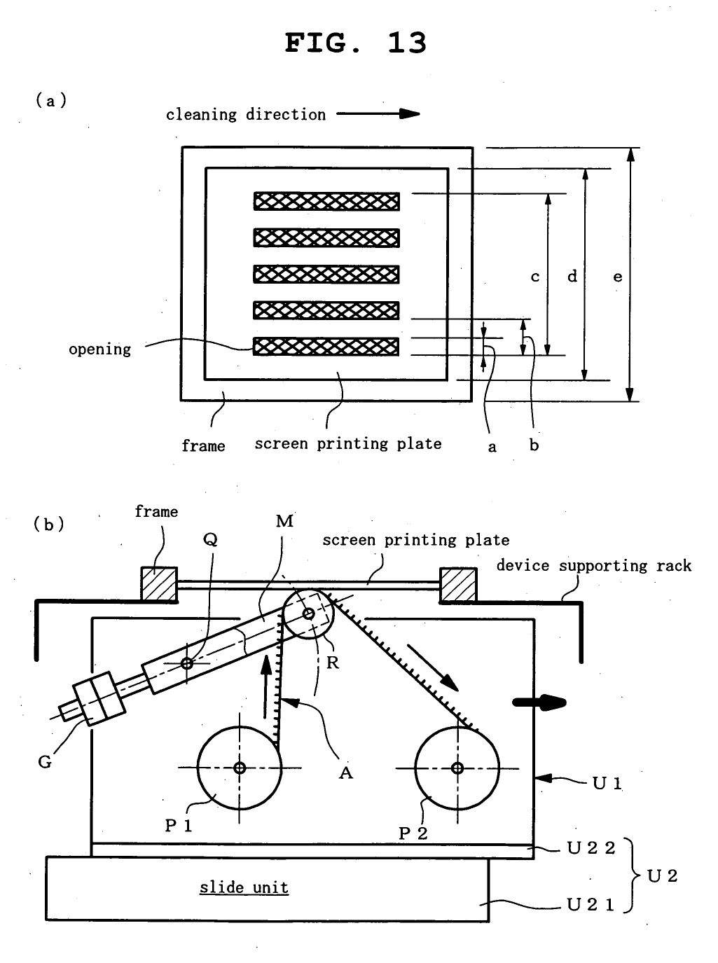

While a PET film was used as a cleaning object in the above-mentioned Example 1 to examine a preferable embodiment of the cleaning sheet, an actual screen printing plate was used as a cleaning object in this Example. The screen printing plate is a member for forming a fluorescent material layer of PDP as shown in FIG. 13(a), which was diverted for use in the experiment.

Moreover, to reproduce the state of use of the cleaning sheet in the actual screen printing apparatus as accurately as possible, a cleaning test apparatus shown in FIG. 13(b) was manufactured.

In the actual screen printing apparatus, a cleaning apparatus set back at the side moves to the plate surface area and automatically wipes off a back paste during the interval of screen printing. The cleaning test apparatus as shown in FIG. 13(b) is able to change pressurization conditions, reeling speed of the sheet, whole advance speed and the like while reproducing the cleaning movement in an actual machine, and examine preferable mode and cleaning conditions.

The screen printing plate, specification of the cleaning test apparatus and test conditions are first explained. (Specification of screen printing plate)

FIG. 13(a) shows a plate surface of a screen printing plate used as a cleaning object in this Example. The main specification such as the size, material, structure and the like of each part are as follows.

width a of opening of screen printing plate: 0.075 mm,

pitch (period) b of opening: 1.075 mm,

whole pattern area width c of opening: 160 mm (size of

opening in the longitudinal direction 160 mm)

size d of one inner side of frame (square): 280 mm

size d of one inner side of frame (square): 320 mm

material of film: diazo photosensitive emulsion

material of screen mesh cloth (net) and line diameter:

stainless, 20 μm

bias: 22.5 degrees

tension: 0.85 mm (measured by tension gauge STG75)

thickness of raw film: about 52 μm (thickness of screen

mesh cloth about 42 μm, thickness of emulsion about 10 μm)

The direction of cleaning is as shown in FIG. 13(a) with an arrow, which is along the longitudinal direction of the opening.

(Overall Constitution of Cleaning Test Apparatus)

FIG. 13(b) shows the constitution of the main part of the cleaning test apparatus. This test apparatus is constructed on a rack supporting the entire apparatus. To show the inner structure, the rack is suggested with a thick dashed line and is not actually shown.

As shown in the Figure, an upper surface of the rack has an opening, in which a screen printing plate is set with a plate surface facing downward, and the plate surface can be cleaned by the cleaning mechanism inside the rack. The structure relating to the attachment and detachment of the screen printing plate is omitted in the Figure.

Inside the rack, a cleaning mechanism Ul is constructed on a slide mechanism U2 such that it can slide in the horizontal direction (right and left directions in the Figure), and the sheet is fed forward (direction heading for the right of the Figure) with a contact face of the cleaning sheet being pressed against the plate surface of the screen printing plate, along with which the cleaning mechanism U1 itself moves forward to achieve the use of FIG. 2.

(Slide Mechanism)

The slide mechanism U2 is a unit consisting of a fixed part U21 mounted on the rack and a movable part U22 set on the cleaning mechanism. The slide mechanism itself may be of various types, but in this Example, a commercially available one was used, in which a shaft (fixed part) and a linear moving type slide bearing (movable part) are combined.

As a driving source for a linear movement (forward, backward) of the cleaning mechanism U1, an electro-motor (not shown) was used, which can freely control movements of the cleaning mechanism U1 to stop, start and move at a uniform speed.

(Cleaning Mechanism) The cleaning mechanism Ul has a sheet feeding mechanism to deliver a cleaning sheet A, wherein the cleaning sheet A is sent from a reel-out roll (feed reel P1) over to a push roller R and then to a reel-in roll (take-up reel P2).

The cleaning sheet A has a web-like shape (width 160 mm) to include a full width 160 mm of the area of the opening of the screen printing plate. The width of the push roller R (distance between both end-faces of roller) was set to 200 mm and the roller radius was set to 17.5 mm in consideration of the width of the cleaning sheet A.

The driving source of the sheet feeding is an electric motor connected to the center shaft of a take-up reel P2 via a transmission. The number of revolutions of the electric motor can be controlled by a transmission to freely change the sheet feeding speed.

The push roller R and feed reel P1 are idle rotation rollers free of a driving power.

The push roller R is installed at one of the terminal portions of an arm M, and the arm M can rotate about a rotational horizontal shaft Q, like a lever or balance, and a weight G for controlling a push load is installed at the other terminal portion of the arm M. By this constitution, the push roller R at the terminal portion of the arm can apply a pressing force according to the weight and position thereof on the other end on the cleaning sheet A.

The weight G includes multiple kinds of weights, and they enable to finely adjust the position on the arm (center distance between weight G and central axis of arm). The load applied by the push roller R on the cleaning sheet A is directly measured by a push-pull gauge at the pressing point of the roller R and can be adjusted based on the total weights and position thereof. The range of the applicable pressing load is 0-3.0 kg, and it was set to 2.6 kg in the test.

The feed speed of the cleaning sheet (feed rate from reel P1) was set to 20 mm/sec, and the moving speed of the whole cleaning mechanism U1 was set to 50 mm/sec (cleaning sheet is rubbed against the screen printing plate at a relative speed of 70 mm/sec at the apex of push roller R).

The feed rate of the cleaning sheet and the moving speed of the whole cleaning mechanism are set on the assumption that the consumption length (sheet consumption amount) of the cleaning sheet to the length of the cleaning area (160 mm) of the screen printing plate is 40% (64 mm).

For example, when the feed rate pf the cleaning sheet increases, a higher amount of the cleaning sheet is consumed for the same cleaning area, and the amount of paste collected in individual concave parts decreases, which in turn varies the preferable values of the concave part. While the consumption amount to optimize the concave convex is not particularly limited, any consumption amount can be determined after confirmation using the test apparatus. The sheet consumption amount of about 10%-70%, particularly the sheet consumption amount assumed in this Example of about 40% is economical in practice, and suitable for determining the actual range of the concave convex.

(Cleaning Test)

To reproduce accumulation of the paste on the plate surface of the screen printing plate, a fluorescent material paste was applied to the plate surface side with a squeegee. The coating area (=cleaning area) was a square of width 160 mm and length (size in the advance direction of the cleaning sheet) 160 mm.

This screen printing plate was set on the cleaning test apparatus under the above-mentioned setting conditions, and a cleaning test was performed after changing the various specifications of each part of the cleaning sheet of the present invention (Example products).

The cleaning sheet used was produced from the same materials as used in the above-mentioned Example 1 by the same production processes, and 8 kinds of Example products 5-12 having various widths w1 of the convex part, the widths of the concave part w2, base sheet thickness h1 and convex part heights h2 were subjected to the cleaning test. The size of each part of the Example products is as shown in the following Table 2.

The Comparative Example product used in Example 1 was also used in this Example, which was applied to the entire application area and peeled off (i.e., consumption amount 100%), and the removal performance was evaluated in the same manner as for the Example products.

The residual amount of the paste on the plate surface of the screen printing plate after cleaning was confirmed with a digital microscope.

The amount of the sheet used, paste removal performance and overall evaluation of the Example products 5-12 and Comparative Example product are shown in the following Table 2.

For paste removal performance and overall evaluation, removal of the back paste by not less than 70% was marked with “O”, removal of the back paste by not less than 40% was marked with “Δ”, and removal of the back paste by less than 40% was marked with “x”.

The overall evaluation was based on the removal performance and the amount of use, wherein “O” means both were fine, and “Δ” means one of them was fine.

TABLE 2

| | | | | | amount | paste | |
|---|---|---|---|---|---|---|---|
| | | | | | of | removal | overall |
| | w1 | w2 | h1 | h2 | sheet | perfor- | evalua- |
| | [μm] | [μm] | [μm] | [μm] | used | mance | tion |
| Example | 100 | 100 | 55 | 45 | 64 | ◯ | ◯ |
| product 5 | | | | | | | |
| Example | 50 | 150 | 70 | 30 | 64 | ◯ | ◯ |
| product 6 | | | | | | | |
| Example | 60 | 140 | 110 | 20 | 64 | ◯ | ◯ |
| product 7 | | | | | | | |
| Example | 50 | 50 | 70 | 30 | 64 | ◯ | ◯ |
| product 8 | | | | | | | |
| Example | 25 | 75 | 85 | 15 | 64 | ◯ | ◯ |
| product 9 | | | | | | | |
| Example | 25 | 25 | 85 | 15 | 64 | ◯ | ◯ |
| product 10 | | | | | | | |
| Example | 50 | 100 | 70 | 30 | 64 | ◯ | ◯ |
| product 11 | | | | | | | |
| Example | 25 | 50 | 85 | 15 | 64 | ◯ | ◯ |
| product 12 | | | | | | | |

| | | | | |
|---|---|---|---|---|
| Comparative | adhesive sheet | 160 | ◯ | Δ |
| Example | | | | |
| product | | | | |

As is clear from the above-mentioned Table 2, while the mode of concave convex of the Example products was different from that of Example 1, like Example 1, the Example products 5-12 and Comparative Example product were fine in paste removal performance. However, the Comparative Example product required the same length of the sheet as the paste coat area to be removed since the product was of an adhesive type. Thus, the Comparative Example product was uneconomical as compared to the Example products, which resulted in the overall evaluation of not fine.

### INDUSTRIAL APPLICABILITY

The cleaning sheet of the present invention can be used for cleaning (removing) various objects to be removed such as paste, ink and the like, which attached to the cleaning object, and particularly preferably used as a cleaning sheet for wiping a back paste on the contact face of the screen printing plate during the production of a fluorescent material layer to be incorporated into various flat panel displays represented by a plasma display panel (PDP) and the like.

This application is based on patent application Nos. 2005-154154 and 2006-113355 filed in Japan, the contents of which are incorporated in full herein by this reference.

1. A cleaning sheet for removing a removal target by rubbing the sheet against a cleaning object, wherein
at least one of the both surfaces of the sheet is a contact face to be rubbed against the cleaning object and the contact face has a concave convex plane.

2. The cleaning sheet of claim 1, wherein the concave convex pattern is a stripe pattern comprising ridge line-like convex parts disposed at intervals on a sheet face.

3. The cleaning sheet of claim 2, wherein the sheet has a form of a band tape, and the ridge line-like convex part extends in a direction forming a right angle or a non-right angle with the longitudinal direction of the tape.

4. The cleaning sheet of claim 2, wherein the ridge line-like convex part has a cross sectional shape when cut perpendicularly to the longitudinal direction of the ridge line of any of a rectangular wave, a triangular wave, a saw tooth wave, a semicircle and a semi-ellipse.

5. The cleaning sheet of claim 2, wherein the ridge line-like convex part has a full width of 10 μm-2000 μm and a height of 10 μm-1000 μm.

6. The cleaning sheet of claim 1, wherein the concave convex pattern forms a net shape comprised of ridge line-like convex parts on a sheet face, and the net comprises meshes of relative concaves.

7. The cleaning sheet of claim 6, wherein the ridge line-like convex part has a cross sectional shape when cut perpendicularly to the longitudinal direction of the ridge line of any of a rectangular wave, a triangular wave, a saw tooth wave, a semicircle and a semi-ellipse.

8. The cleaning sheet of claim 6, wherein the ridge line-like convex part has a full width of 10 μm-2000 μm and a height of 10 μm-1000 μm.

9. The cleaning sheet of claim 1, wherein the concave convex pattern is formed by disposing separately occurring concave parts at random or regularly on a sheet face.

10. The cleaning sheet of claim 1 used for cleaning a screen printing plate.

11. The cleaning sheet of claim 1, wherein the cleaning object is a screen printing plate to form a fluorescent material layer of a flat panel display, and the removal target is a fluorescent material paste.

12. A cleaning method using the cleaning sheet of claim 1, which comprises rubbing a contact face of the cleaning sheet against a cleaning object to remove a removal target thereon.

13. The cleaning method of claim 12, wherein the cleaning sheet comprises a concave convex pattern which is a stripe pattern comprising ridge line-like convex parts disposed at intervals on a sheet face.

14. The cleaning method of claim 13, wherein the ridge line-like convex part has a cross sectional shape when cut perpendicularly to the longitudinal direction of the ridge line of any of a rectangular wave, a triangular wave, a saw tooth wave, a semicircle and a semi-ellipse.

15. The cleaning method of claim 13, wherein the ridge line-like convex part has a full width of 10 μm-2000 μm and a height of 10 μm-1000 μm.

16. The cleaning method of claim 12, which is used for cleaning a screen printing plate.

17. The cleaning method of claim 12, wherein the cleaning object is a screen printing plate to form a fluorescent material layer of a flat panel display and the removal target is a fluorescent material paste.
